(19) United States
(12) Patent Application Publication
(10) Pub. No.: US 2021/0355732 A1
(43) Pub. Date: Nov. 18, 2021

(54) AUTOMATIC SAFETY LOCKING DEVICE FOR WALL BEDS

(71) Applicant: BESTAR INC., Lac-Megantic (CA)

(72) Inventor: Alain Couture, Frontenac (CA)

(21) Appl. No.: 17/302,870

(22) Filed: May 14, 2021

Related U.S. Application Data
(60) Provisional application No. 63/025,323, filed on May 15, 2020.

(51) Int. Cl. E05F 5/06; A47C 17/46

(52) U.S. Cl. CPC E05F 5/06; A47C 17/46; E05Y 2201/654; E05Y 2201/248; E05Y 2600/622; E05Y 2900/20; E05Y 2201/232; E05Y 2800/296

(57) ABSTRACT

There is provided an automatic locking device for mounting to a wall-bed having a frame portion anchored to a wall and resting on a floor and having a pivotable mattress support portion adapted to be pivoted to upright storage position and to a deployed horizontal position as a sleeping surface. The automatic locking mechanism being mounted to the bed frame portion anchored to a wall and being automatically actuated by any sudden forward tipping movement of the frame portion should it become dislodged from the wall while the mattress support portion is in its deployed horizontal position. Also provided is a wall bed and kit comprising the automatic locking device of the present invention.

### CROSS REFERENCE TO RELATED APPLICATION

None.

### TECHNICAL FIELD

The invention relates to a wall-mounted bed with a safety locking device configured to prevent accidental closing of the bed.

### BACKGROUND OF THE ART

Wall mounted beds, also known as murphy beds or wall beds, have been sold since the early 20^{th} century. These beds are used in locations where space is at a premium, allowing the user to fold the bed up to a vertical closed position on the wall during waking hours and to lay it in an open horizontal position for use during sleeping hours. As urbanization leads to increased population density in urban areas and space becomes scarcer and more costly, such beds are finding increasing demand.

Most wall mounted beds are sold as a kit of parts to be assembled and installed by the purchaser. It is important for purchaser to properly secure the vertical framing of the bed to the wall such as by screwing into joist. One risk associated with improper assembly and mounting of wall mounted beds is for the vertical framing of the bed to unexpectedly rip off the back wall while the bed is in the open position and for the vertical framing to collapse onto the horizontal bed and potentially trap or injure someone.

Although some prior solutions for locking wall mounted beds into an open or closed position exist, these devices require locking or unlocking the bed into its open or closed position each time, which may be cumbersome to many users. A user may also forget to lock the bed in position. These prior art devices also only work by keeping the bed in a fully open or fully closed position, and therefore do not act to prevent the bed from involuntarily closing during rotation of the bed from a fully open to a fully closed position, or vice versa.

There remains a need for an improved locking device which does not require user input and prevents inadvertent closing of the wall mounted bed assembly if the vertical framing of the bed were to rip off the back wall.

### SUMMARY

In one embodiment, there is provided an automatic locking device for mounting to a wall-bed having a frame portion anchored to a wall and resting on a floor and having a pivotable mattress support portion adapted to be pivoted between an upright storage position and a deployed horizontal position for use as a sleeping surface. The automatic locking mechanism being mounted to the bed frame portion anchored to a wall and the automatic locking mechanism being automatically actuated by any sudden forward tipping movement of the frame portion should it become dislodged from the wall. Also provided is a wall bed and kit comprising the automatic locking device of the present invention.

### BRIEF DESCRIPTION OF THE DRAWINGS

Having thus generally described the nature of the invention, reference will now be made to the accompanying drawings, showing by way of illustration example embodiments thereof and in which:

FIG. 1 is a back left perspective view of a wall bed assembly having the automatic safety locking device;

FIG. 2 is a back right perspective view of the wall bed of FIG. 1;

FIG. 3 is a front left perspective view of the wall bed of FIG. 1;

FIG. 4 is a perspective view of a mounting plate for mounting a portion of the safety locking device to a bed;

FIG. 5 is a partially exploded perspective view of a portion of the safety locking device and the bed;

FIG. 6 is a front view of the frame mounting portion of the safety locking device of FIG. 5;

FIG. 7 is a partially exploded perspective view of a rack assembly and spring mounted locking assembly of the safety locking device shown in FIG. 5;

FIG. 8 is an exploded view perspective of the spring mounted locking assembly of the safety locking device shown in FIG. 5; and

FIG. 9 is a perspective view of a locking pin of the spring mounted locking assembly shown in FIG. 8.

### DETAILED DESCRIPTION

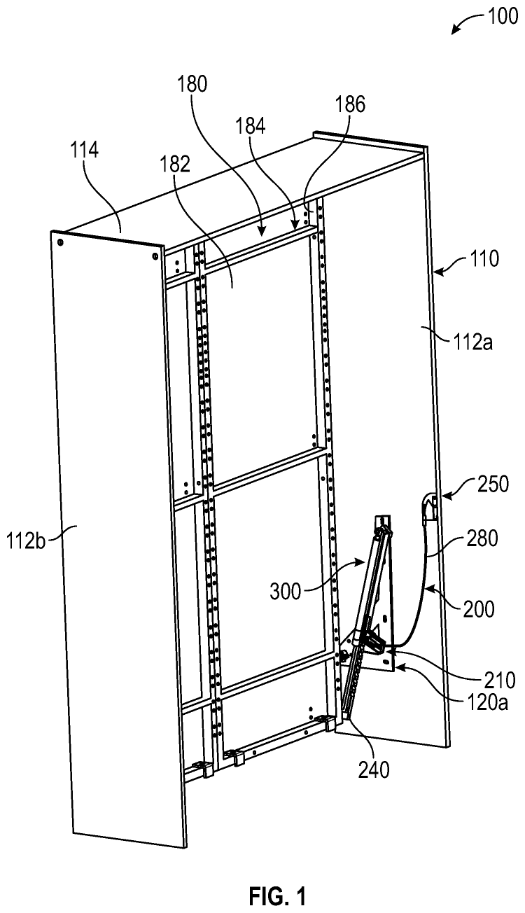

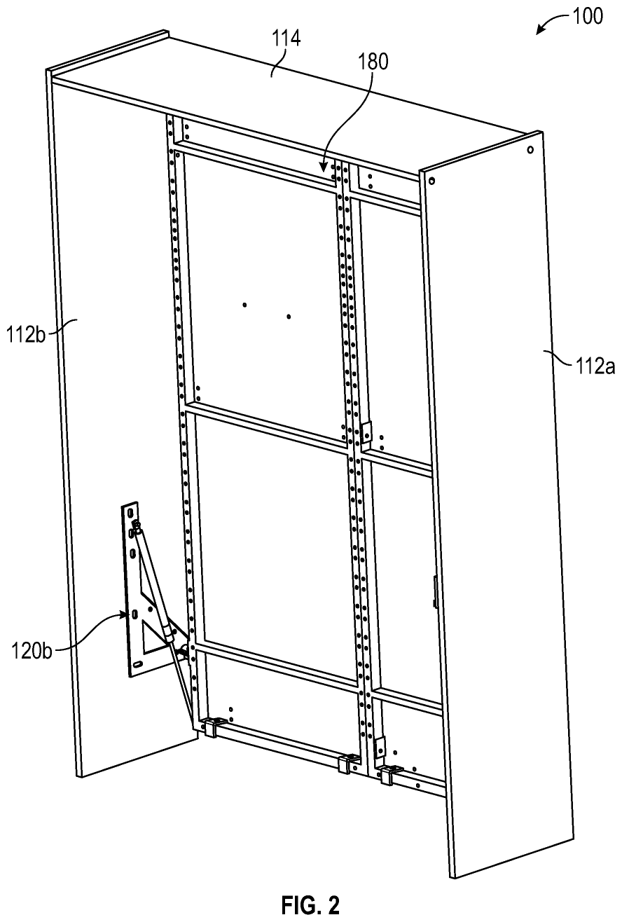

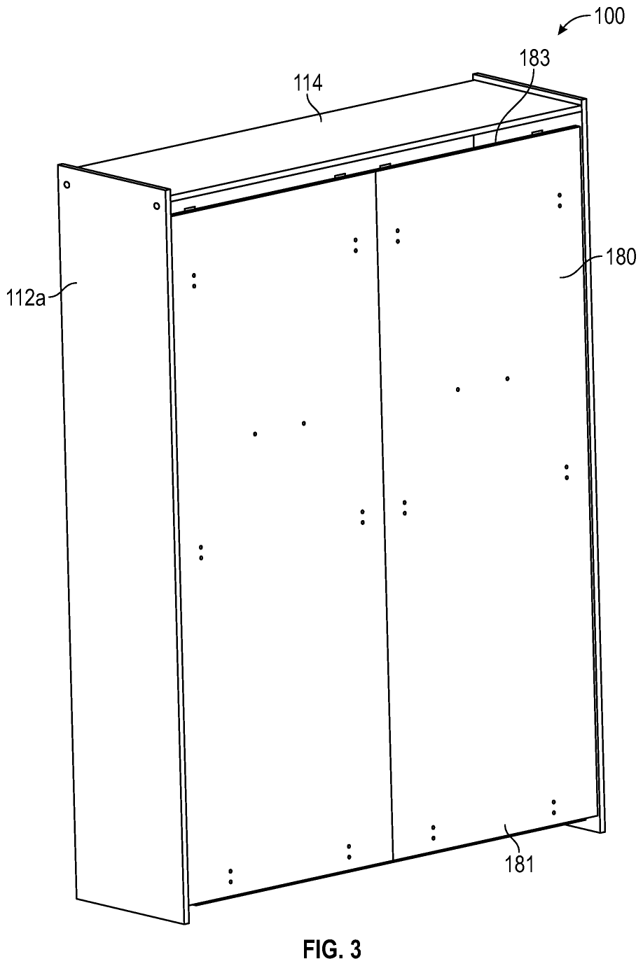

Referring first to FIGS. 1-5, there is shown one embodiment of a wall bed assembly 100. In this embodiment, the bed assembly 100 comprises a frame 110 which includes two side walls 112a, 112b, a top wall 114 and a pivotable mattress support 180. The bottom portions of side walls 112a and 112b are sized and configured to rest on the floor and provide stability to the assembly 100. The upper portion of assembly 100 is suitably anchored to a back wall (not shown) to prevent tipping of assembly 100 towards the floor.

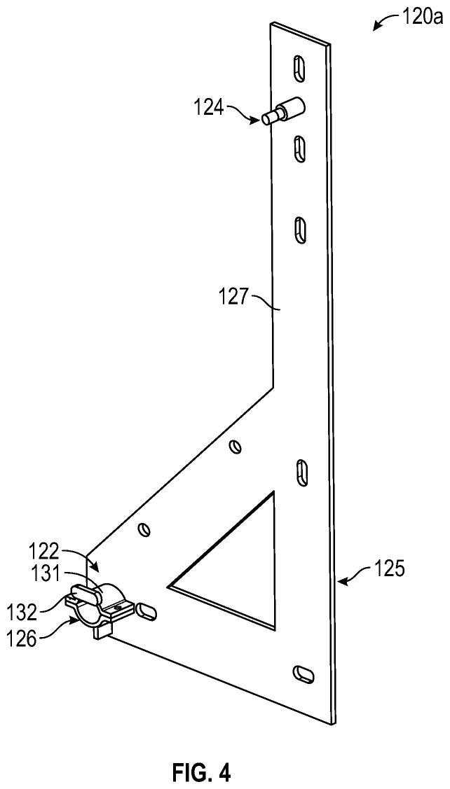

The bed assembly 100 comprises a pair of mounting plates 120a, 120b. The mounting plates 120a, 120b are identical so 120a only will be described. The mounting plate 120a is fastened to the sidewall 112a. As illustrated by FIG. 4, in an embodiment, mounting plate 120a has the shape of a set square comprising a triangle shaped portion 125 with angles at 90°, 45° and 45° and a straight portion 127 extending outwards from the top of the triangle shaped portion 125. The mounting plate 120a has two pivot points, a lower pivot point 122 located in the triangle shaped portion 125 and an upper pivot point 124 mounted in the straight portion 127. A bracket 126 is mounted onto the lower pivot point 122. The bracket 126 is configured to receive therein a ball bearing to allow rotation of the mattress support 180 as illustrated in FIG. 1.

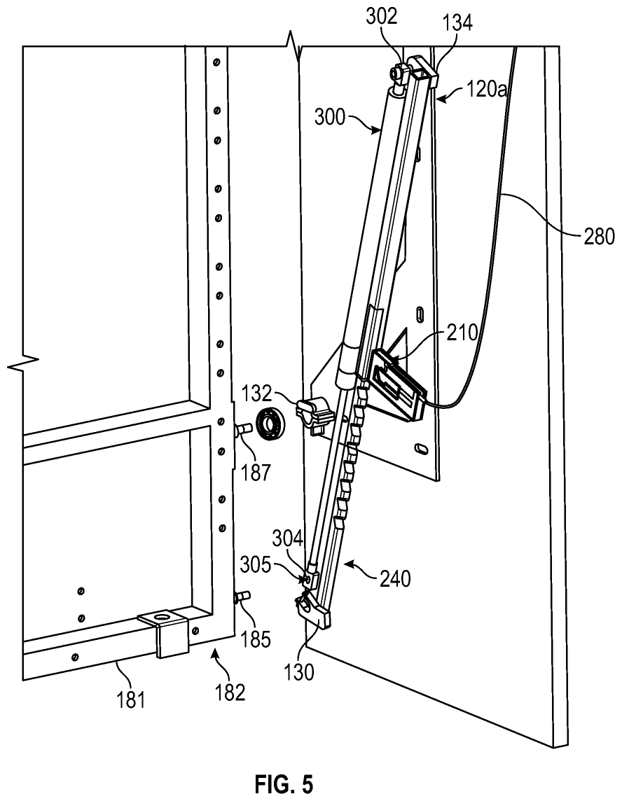

Still referring to FIG. 1, the mattress support assembly 180 is comprised of a base 182 mounted onto the frame structure 184. Base 182 is comprised of a sheet of metal or wood or any other suitably rigid material. The frame structure 184 may also be wood or metal or any other suitable material. The frame structure 184 is composed of horizontal and vertical beam members 186, providing rigidity and support for a sleeping mattress (not shown) to be mounted thereunto. The mattress support assembly 180 has a top end 183 and a bottom end 181. Referring now to FIG. 5, a lower protrusion 185 and an upper protrusion 187 are proximal to the bottom end 181 of the mattress support 180 and extend orthogonal to the longitudinal axis of the base 182. The lower protrusion 185 is rotatably received in a bottom end of a gas damper 300 with a lower bracket 130 welded to the rack assembly and provided between the bottom end 304 of the gas damper 300 and the frame 184 of the mattress support 180. The upper protrusion 187 is rotatably received in the bracket 126 of the mounting plate 120a via a ball bearing with an upper part 131 of the bracket 126 having a spacer 132 between the bracket 126 and the frame 184 of the mattress support 180. The upper part 131 of the bracket 126 is fastened to the bracket 126 after placing of the ball bearing therein. The upper protrusion 187 acts as a pivot point, while the lower protrusion 185 connects the gas damper 300 to the mattress support 180, allowing controlled movement of the bottom end 181 of the mattress support 180 along an arc having a center at the pivot point at the upper protrusion 187. The interaction between the pivot point at the upper protrusion 187 and the movement of the lower protrusion 185 allows rotation of the mattress support 180 so that it may be laid flat along the horizontal plane during use or be retracted into the vertical plane during storage.

The gas damper 300 will now be further described. The gas damper 300 has a top end 302 and a bottom end 304. The top end 302 is pivotably mounted to the mounting plate 120a and to the side wall 112a, while the bottom end 304 is securably mounted only to the lower protrusion 185 to allow movement of the lower protrusion 185 along an arc. Although a gas damper is used in the illustrated embodiment, any other damper (e.g. springs) may also be used. The gas damper 300 facilitates retraction and extension of the mattress support 180 from the horizontal to the vertical position by reducing the amount of force required by the user when switching between the horizontal and vertical positions. When the user pulls the bed down towards the horizontal position, the gas in the gas damper 300 is compressed, softening the downward motion of the mattress support 180. When the user wishes to retract the bed back to the vertical position, the compressed gas exerts an assistive force as it expands.

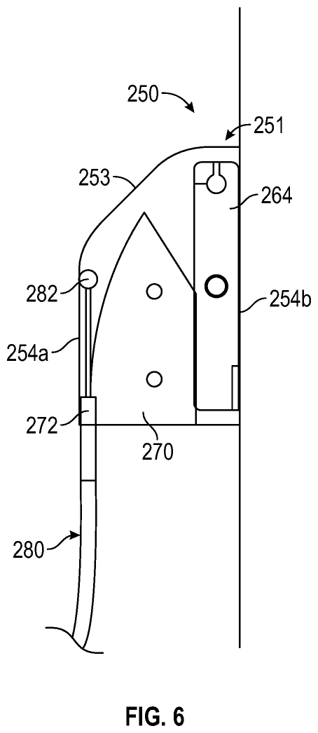

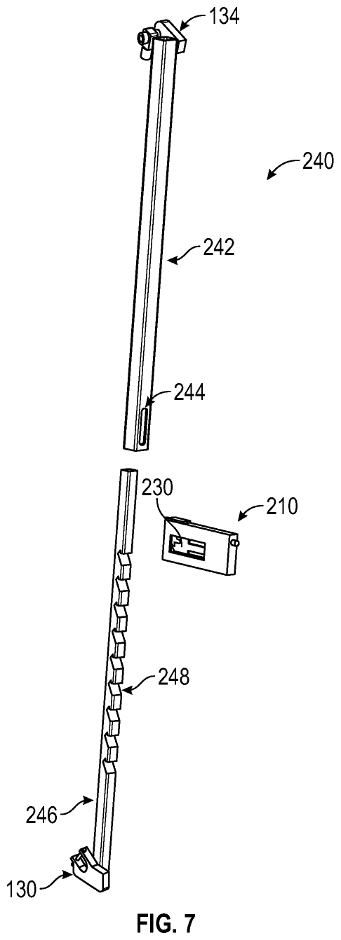

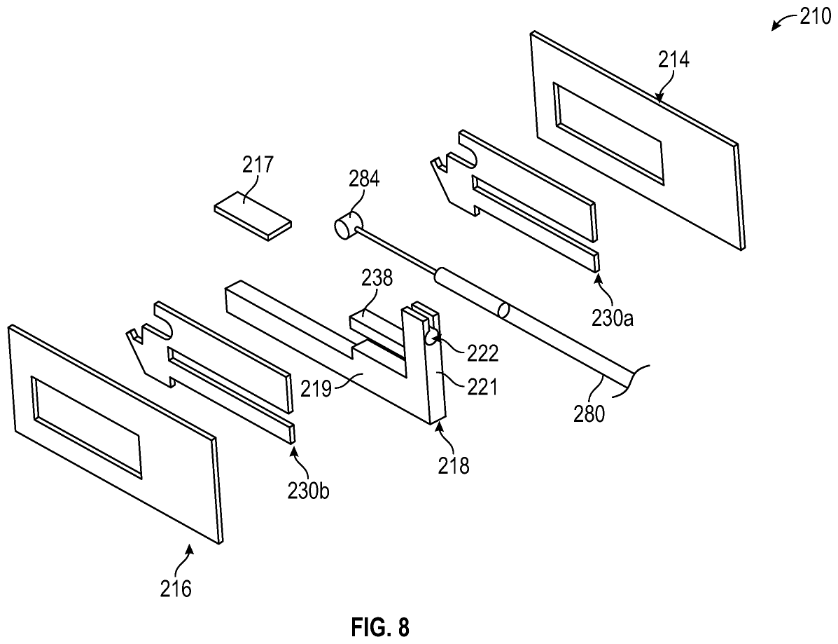

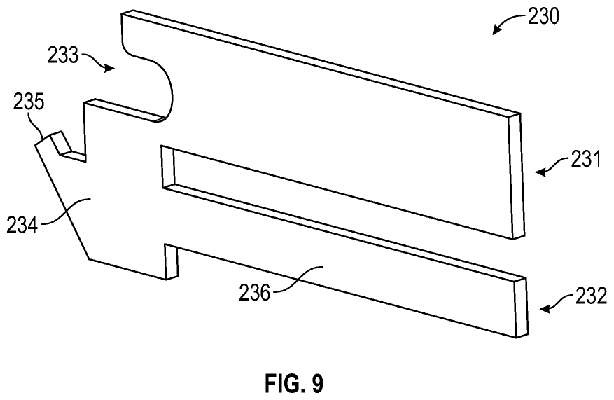

With reference to FIGS. 5-9, the gas damper 300 is additionally coupled with a locking assembly 200. The locking assembly 200 provides an added safety feature to protect the user from unexpected closing of the wall bed assembly 100 should the wall bed assembly unexpectedly rip off the wall anchor(s) onto which it is installed and tip forward towards the mattress support 180 while in the deployed open horizontal position. The locking assembly 200 comprises a frame mounted portion 250, a transmission cable 280, a spring mounted locking assembly 210 and a rack assembly 240 coupled to the gas damper 300 and adapted to receive the spring mounted locking assembly 210. The frame mounted portion 250 is mounted to the side wall 112a and consists of an enclosure 251 having a bottom end 252, a top end 253, as well as left and right sides 254a, 254b. The enclosure 251 is comprised of a front plate 260 and a back plate 262, the front and back plates 260, 262 spaced apart using a rectangular spacer 264 and a curved spacer 270. The curved spacer 270 is configured to be proximal to the transmission cable 270 on the left side 254a while the rectangular spacer 264 is proximal to the curved spacer 270 on the right side 254b of the enclosure 251. The curved spacer 270 has a transmission cable receiving portion 272 which consists of a flat top surface 274 with an aperture 275 therein adapted to receive a first end 282 of the transmission cable 280. The first end 282 of the transmission cable 280 comprises of a nipple, the nipple being larger than the aperture 275 and thus being engaged therein to maintain the transmission cable 280 in the frame mounted portion 250. In one embodiment, the top end 253 of the frame mounted portion 250 is not covered so as to allow the nipple of the first end 282 of the cable 280 to be placed inside the cable receiving portion 272. In another embodiment, the front and back plates 260, 262 may be fastened to one another, so as to allow the user to unfasten them in order to place the first end 282 of the cable 280 therein. Other variations may be evident to the skilled addressee.

In the illustrated embodiment the transmission cable 280 is similar to a bicycle transmission cable, though other transmission means may be evident to the skilled addressee. The transmission cable 280 has a second end 284 engaging the spring mounted locking assembly 210. The spring mounted locking assembly 210 consists of an enclosure, the enclosure comprising a front plate 214, a back plate 216 and a middle frame 218. The front and back plates are rectangular shaped, with a rectangular opening therein to allow inspection of the mechanism of the spring mounted locking assembly 210. The middle frame has a bottom portion 219 on the top of which the locking pins 230a, 230b are received and the bottom of which forms the bottom face of the spring mounted locking assembly 210. The middle frame 218 further has a spring 238 for biasing the locking pins 230a, 230b, as will be described further below. The middle frame 218 also includes a side portion 221, with an opening 222 therein for removably receiving the transmission cable 280 and for engaging the nipple of the second end 284 of said cable to prevent the second end 284 from exiting the enclosure of the spring mounted locking assembly 210. The front and back plates 214, 216 along with the middle frame 218 combine to provide an enclosure having an opening therein for receiving locking pins 230a, 230b. Once the second end 284 of the transmission cable 280 is received in the enclosure of the spring mounted locking assembly, the enclosure may be closed using a top wall 217. The top wall 217 is welded to the front and back plates 214, 216. Other closing means may also be evident, such as adhesives or fasteners. In another embodiment, a top side of the spring mounted locking assembly 210 may be left open to allow the nipple of the second end 284 of the transmission cable 280 to be removably placed inside the enclosure. Other variations may be evident to the skilled addressee.

The spring mounted locking assembly 210 is fastened to the rack assembly 240 comprising a rack 246 and a rack cover 242, at the rack cover 242 and positioned over a pin receiving aperture 244 in the rack cover 242. The rack cover 242 is a hollow rectangular beam configured to slidably receive a rack 246. The rack 246 is a solid beam having a plurality of pin receiving slots 248 along a longitudinal axis of the rack 246. The pin receiving slots 248 are each configured to receive the locking pins 230a, 230b of the spring mounted locking assembly 210.

The locking pin 230 (representing either of the identical locking pins 230a, 230b) comprises a transmission cable receiving portion 231 and a locking portion 232. The transmission cable receiving portion 231 is generally rectangular, having a slot 233 for receiving and engaging therein a nipple of the second end 284 of the transmission cable 280. The locking portion 232 has a front end 234 shaped generally like a semi-profile of an arrow with a tooth 235 extending outwardly therefrom. The locking portion 232 further has a spring receiving portion 236 formed integral with the front end 234, the spring receiving portion 236 being configured to sit against the spring 238. Although a spring is used in the illustrated embodiment, any other biasing means may be used as deemed suitable by the skilled addressee. Additionally, although the illustrated embodiment only prevents movement in one direction, it is envisaged that an alternative embodiment may prevent movement in both directions, for example through use of two opposing teeth and an altered profile of the pin receiving slots.

While the transmission cable 280 is in tension, engaged at the nipple of the first end 282 by the frame mounted portion 250, the second end 284 of the cable 280 maintains the position of the locking pin 230 in the unengaged position with the spring 238 compressed. As long as the position of the frame 110 of the wall bed assembly 100 does not change, the cable 280 will remain in tension. If, however, the frame 110 was to be disengaged from its anchor point (e.g. a back wall) and begins to tip forward and collapse onto the mattress support 180, the frame mounting portion 250 will be brought in a position closer to the mattress support assembly 180, resulting in the cable 280 slackening. With the cable 280 no longer exerting any force on the locking pin 230, the spring 238 will push the locking pin 230 into the pin receiving aperture 244 of the rack cover 242 until it is received in one of the pin receiving slots 248, preventing further movement of the rack 246. The rack 246 is coupled to the gas damper 300 through the lower bracket 130 while the rack cover 242 is coupled to the gas piston through an upper bracket 134. In one embodiment, the upper and lower brackets 134, 130 are welded to the rack cover 242 and rack 246. Other securing means may be evident to the skilled addressee. This coupling of the rack 246 and rack cover 242 to the gas damper 300 prevents the gas damper 300 from compressing any further, thereby maintaining the relative position of the frame 110 to the mattress support 180. The locking mechanism thus prevents any potential injury from occurring to the user(s) of the bed assembly 100 as a result of the frame 110 disengaging from its anchor point and collapsing onto the user(s). An additional feature of the safety locking device described herein is that once triggered the device will remain locked by default and until further human intervention. It is envisaged that, for example, technicians may be sent to inspect the bed and if still usable the technicians could both reset the system and to ensure proper anchoring of the wall bed onto a wall to ensure the safety of the bed user. It is also added that the invention described herein ensures safe use and prevents the frame 110 from collapsing onto the mattress support assembly 180 during any rotation angle (e.g. while the bed is being opened or closed) due to the plurality of pin receiving slots 248 on the rack 246. In other words, the function of the safety locking device in the system of the present invention is not dependent on the angle of the mattress support assembly 180. Once the safety locking device is set it does not need to be monitored, it will be continuously active without further user intervention ensuring peace of mind. Lastly, the safety locking device may be retrofittable to an existing wall bed or it may as part of a kit of a wall bed containing the safety locking device.

Although the embodiment described above is mechanical, operating through tension of the transmission cable 280, it is envisaged that other transmission means may also be used. For example, the transmission cable 280 and spring mounted locking assembly 210 may be replaced by a pneumatic system. In such a pneumatic system there may, for example be two pneumatic cylinders. A first pneumatic cylinder would be placed on the wall (replacing the transmission cable 280 and frame mounted portion 250 of the mechanical assembly), while the spring of the spring mounted locking assembly 210 may be replaced by a second pneumatic cylinder. The first pneumatic cylinder may then act on the second pneumatic cylinder when the frame 110 is disengaged from its anchor point (e.g. a back wall), such that an end of the second cylinder is either received in the pin receiving slots 248 of the rack 246 or that the second cylinder acts on a pin which is then received in the pin receiving slots 248 of the rack 246. Other pneumatic means may also be evident to the skilled addressee, as well as other transmission means such as a hydraulic assembly or even an electric assembly. It is envisaged that in an electric assembly, an electric switch would detect the frame 110 being disengaged and would electrically activate a lock to prevent further movement of the frame 110 relative to the mattress support 180.

The embodiments described above are intended to be exemplary only. The scope of the invention is therefore intended to be limited solely by the appended claims.

1. A kit for an automatic locking device for a wall bed having a frame, the kit for the automatic locking device comprising:
a frame mounted portion for mounting onto the frame of the wall bed;
a transmission means having a first end received in the frame mounted portion;
a locking assembly comprising a damper, a locking pin mounted to the damper, the locking pin being configured to receive and engage a second end of the transmission means, wherein the transmission means is kept in tension between the locking assembly and the frame mounted portion and maintains the damper in a compressed state;
a body having a plurality of slots configured to receive the locking pin, wherein a slackening of the transmission means results in the damper pushing the locking pin into one of the slots.

2. The kit of claim 1 wherein the transmission means is a cable.

3. The kit of claim 2 wherein the cable has distal ends being sized and configured to be securely attached to said frame and to said locking assembly respectively.

4. A wall bed comprising the kit of claim 1.
